(19) United States
(12) Patent Application Publication
(10) Pub. No.: US 2010/0063247 A1
(43) Pub. Date: Mar. 11, 2010

(54) CHLORINATED VINYL CHLORIDE-BASED RESIN AND MANUFACTURING METHOD

(75) Inventors: Toshifumi Sanni, Shunan-shi (JP); Hideaki Tanaka, Shunan-shi (JP); Masatoshi Harada, Shunan-shi (JP)

Correspondence Address: SUGHRUE MION, PLLC, 2100 PENNSYLVANIA AVENUE, N.W., SUITE 800, WASHINGTON, DC, 20037, US

(73) Assignees: SEKISUI CHEMICAL CO., LTD., Osaka-shi, Osaka (JP); TOKUYAMA SEKISUI CO., LTD., Shunan-shi, Yamaguchi (JP)

(21) Appl. No.: 12/516,296

(22) PCT Filed: Nov. 24, 2006
(86) PCT No.: PCT/JP2006/323400

§ 371 Date: May 26, 2009

(51) Int. Cl. C08G 79/00

(52) U.S. Cl. 528/392

(57) ABSTRACT

An object of the present invention is to provide a chlorinated vinyl chloride-based resin with few unstable structures and excellent thermal stability, and a molding article. The chlorinated vinyl chloride-based resin of the invention is an resin in which a chlorine content is 65 wt % or higher, and less than 69 wt %, —CCl₂— is in an amount of 6.2 mol % or less, —CHCl— is in an amount of 58.0 mol % or higher, and —CH₂— is in an amount of 35.8 mol % or less contained in a molecular structure.

### TECHNICAL FIELD

The present invention relates to a chlorinated vinyl chloride-based resin and a manufacturing method of the same.

### BACKGROUND ART

A vinyl chloride-based resin (hereinafter referred to as PVC) is used in many fields as a material with excellent mechanical strength, weather resistance, chemical resistance, and so on. Because of its poor heat resistance, however, the PVC has been chlorinated to develop a chlorinated vinyl chloride-based resin (hereinafter referred to as CPVC) with improved heat resistance.

CPVC has the flame resistance, weather resistance, chemical resistance, and other advantages of PVC, while also having improved mechanical properties at high temperatures, which were a drawback to PVC, and is thus a useful resin in a wide range of applications. Specifically, CPVC retains the excellent flame resistance, weather resistance, chemical resistance, and so forth of PVC, but its thermal deformation temperature is 20 to 40° C. higher than that of PVC, so whereas the upper limit temperature at which PVC can be used is around 60 to 70° C., CPVC can be used at close to 100° C., and therefore finds use in heat-resistant pipes, heat-resistant sheets, heat-resistant industrial plates, and the like.

However, if CPVC has a chlorine content of 65 wt % or more, unstable structures are often produced because of the high proportion of added chlorine atoms, and this is a problem in that it leads to poor thermal stability.

In an effort to solve this problem, various methods have been proposed for manufacturing CPVC with better thermal stability.

For example, a method has been proposed for obtaining a CPVC with good thermal stability by supplying chlorine with an oxygen concentration of 0.05 to 0.35 vol % at a specific flow rate, and chlorinating at a temperature of 55 to 80° C. (see, Patent document 1, for example). With this manufacturing method, however, because the oxygen concentration is high and the reaction is conducted at a low temperature, the thermal stability is not especially excellent, and the material does not stand up well to extended extrusion molding or injection molding.

A different manufacturing method that has been proposed involves using chlorine with an oxygen concentration of 200 ppm or less, and chlorinating under ultraviolet irradiation (see, Patent document 2, for example), but because this manufacturing method involves a reaction at low temperature under ultraviolet irradiation, the resulting CPVC does not have especially excellent thermal stability.

Another method that has been proposed is to control the reaction velocity by using hydrogen peroxide. For example, polyvinyl chloride is suspended in an aqueous medium in a sealable vessel, and the inside of the vessel is put under reduced pressure, after which chlorine is introduced into the vessel and the polyvinyl chloride is chlorinated at a temperature of 90 to 140° C. With this method, at the point when the chlorine content of the polyvinyl chloride in the reaction reaches 60 wt % or higher in the course of the chlorination, the addition of hydrogen peroxide is commenced at a rate of 5 to 50 ppm/hr with respect to the polyvinyl chloride (see, Patent document 3, for example). With this method, however, the reaction velocity is controlled at the point when a specific chlorine content of 60 wt % is reached, regardless of the chlorine content of the CPVC being manufactured, so in the manufacture of a CPVC that can be used in more heat-resistant applications (such as a CPVC with a chlorine content of 65 wt % or higher), since the reaction velocity drops off markedly as the chlorine content rises, productivity is much worse, and a good balance can not be struck between thermal stability and productivity.

[Patent document 1] Japanese Published Examined Appl. S45-30833
[Patent document 2] Japanese Laid-open Patent Appl. H09-328518
[Patent document 3] Japanese Laid-open Patent Appl. 2001-151815

### DISCLOSURE OF THE INVENTION

### Problem to be Solved

The present invention was conceived in light of the above problems, and it is an object thereof to provide a chlorinated vinyl chloride-based resin with few unstable structures and excellent thermal stability, and a molding article.

It is also an object thereof to provide a manufacturing method of the chlorinated vinyl chloride-based resin with excellent productivity and excellent thermal stability due to suppressed occurrence of unstable structures, and particularly a chlorinated vinyl chloride-based resin with a chlorine content of 65 wt % or higher.

### Means for Solving the Problem

A chlorinated vinyl chloride-based resin (CPVC) of the present invention has a chlorine content of 65 wt % or more, and less than 69 wt %, and a —CCl₂— contained in a molecular structure is in an amount of 6.2 mol % or less, a —CHCl— is in an amount of 58.0 mol % or more, and a —CH₂— is in an amount of 35.8 mol % or less.

It is preferable for the CPVC that (1) —CCl₂— is in an amount of 5.9 mol % or less, —CHCl— is in an amount of 59.5 mol % or more, and —CH₂— is in an amount of 34.6 mol % or less, contained in a molecular structure; (2) a tetrad or higher vinyl chloride units contained in the molecular structure is 30.0 mol % or less; (3) UV absorbance at a wavelength of 216 nm is 0.8 or less; and/or (4) the time required for reaching the amount of HCl removal of 7000 ppm at 190° C. is 50 seconds or more.

An another CPVC of the present invention has a chlorine content of 69 wt % or more, and less than 72 wt %, and a —CCl₂— is in an amount of 17.0 mol % or less, a —CHCl— is in an amount of 46.0 mol % or more, and a —CH₂— is in an amount of 37.0 mol % or less, contained in a molecular structure.

It is preferable for the CPVC that (1) —CCl₂— is in an amount of 16.0 mol % or less, —CHCl— is in an amount of 53.5 mol % or more, and —CH₂— is in an amount of 30.5 mol % or less, contained in a molecular structure; (2) a tetrad or higher vinyl chloride units contained in the molecular structure is 18.0 mol % or less; (3) UV absorbance at a wavelength of 216 nm is 8.0 or less; and/or (4) the time required for reaching the amount of HCl removal of 7000 ppm at 190° C. is 100 seconds or more.

Further, in the CPVC of the above, the chlorinated vinyl chloride-based resin is preferably one that is obtainable by introducing liquid chlorine or chlorine gas into the reactor in a state in which vinyl chloride-based resin has been suspended in an aqueous medium in the reactor to chlorinate of a vinyl chloride-based resin, in particular, the chlorination preferably involve no UV irradiation, and may be brought about the excitation of bonding of the vinyl chloride-based resin and chlorine by heat alone or by heat and hydrogen peroxide.

A molded article of the present invention is the molded article that is molded with the CPVC of the above.

Moreover, the method of the present invention for manufacturing CPVC is one in which a vinyl chloride-based resin is dispersed in an aqueous medium inside a sealable reaction vessel, and the interior of the reaction vessel is reduced in pressure, after which chlorine is introduced into the vessel to chlorinate the vinyl chloride-based resin, the method comprises;

controlling a chlorine consumption rate which is the amount of chlorine consumed in 5 minutes per kilogram of raw material vinyl chloride-based resin so that the chlorine consumption rate is in the range of 0.010 and 0.020 kg/PVC-kg·5 min at the point of reaching 5 wt % away from the final chlorine content of the chlorinated vinyl chloride-based resin, and so that the chlorine consumption rate is in the range of 0.005 and 0.015 kg/PVC/kg·5 min at the point of reaching 3 wt % away from the final chlorine content.

In this method, in the case that (1) a final chlorine content is 65 wt % or higher, and less than 70 wt %, the method preferably comprises;

controlling the chlorine consumption rate so that the chlorine consumption rate is in the range of 0.010 and 0.015 kg/PVC-kg·5 min at the point of reaching 5 wt % away from the final chlorine content, and so that the chlorine consumption rate is in the range of 0.005 and 0.010 kg/PVC-kg·5 min at the point of reaching 3 wt % away from the final chlorine content, or in the case that (2) a final chlorine content is 70 wt % or higher, the method preferably comprises;

controlling the chlorine consumption rate so that the chlorine consumption rate is in the range of 0.015 and 0.020 kg/PVC-kg·5 min at the point of reaching 5 wt % away from the final chlorine content, and so that the chlorine consumption rate is in the range of 0.005 and 0.015 kg/PVC-kg·5 min at the point of reaching 3 wt % away from the final chlorine content.

### EFFECT OF THE INVENTION

With the present invention, a CPVC with excellent thermal stability can be obtained with few unstable structures.

Also, because a molded article thereof will have excellent thermal stability, it can be used to advantage in applications such as construction materials, piping machinery, and home building materials, and can be used to particular advantage in large heat-resistant members that need to have heat resistance and thermal stability.

Furthermore, a CPVC with excellent productivity and excellent thermal stability due to suppressed occurrence of unstable structures, and particularly a CPVC with a chlorine content of 65 wt % or higher, can be manufactured easily and simply.

### DETAILED DESCRIPTION OF THE PREFERRED EMBODIMENTS

The chlorinated vinyl chloride-based resin (CPVC) of the present invention is a resin obtained by the chlorination of a vinyl chloride-based resin (PVC).

Examples of PVC include vinyl chloride homopolymers, copolymers of a vinyl chloride monomer (preferably contained in an amount of 50 wt % or more) and a monomer having unsaturated bonds that is copolymerizable with a vinyl chloride monomer, and graft copolymers obtained by the graft copolymerization of a vinyl chloride monomer with a polymer. These polymers may be used individually or in mixtures of two or more.

Examples of the above-mentioned monomer having unsaturated bonds that is copolymerizable with the vinyl chloride monomer include α-olefins such as ethylene, propylene, butylene; vinyl esters such as vinyl acetate, vinyl propionate; vinyl ethers such as butyl vinyl ether, cetyl vinyl ether; (meth)acrylates such as a methyl (meth)acrylate, ethyl (meth)acrylate, butyl acrylate, phenyl methacrylate; aromatic vinyls such as styrene, α-methyl styrene; halogenated vinyl vinyls such as vinylidene chloride, vinylidene fluoride; N-substituted maleimides such as N-phenyl maleimide, N-cyclohexyl maleimide; (meth)acrylic acid, maleic anhydride, acrylonitrile, and the like. These may be used individually or in mixtures of two or more.

There are no particular restrictions on the above-mentioned polymer to which the vinyl chloride is graft copolymerized, so long as it is one to which vinyl chloride can be graft polymerized, but examples include an ethylene-vinyl acetate copolymer, ethylene-vinyl acetate-carbon monoxide copolymer, ethylene-ethyl acrylate copolymer, ethylene-butyl acrylate-carbon monoxide copolymer, ethylene-methyl methacrylate copolymer, ethylene-propylene copolymer, acrylonitrile-butadiene copolymer, polyurethane, chlorinated polyethylene, chlorinated polypropylene, and the like. These may be used individually or in mixtures of two or more.

There are no particular restrictions on the average degree of polymerization of the PVC, but one with the normally used range of 400 to 3000 is preferable, 600 to 1500 are more preferable. When handling and the time entailed by the chlorination reaction are taken into consideration, the average particle size of the PVC is preferably 100 to 200 μm.

There are no particular restrictions on the method for polymerizing the PVC, and any commonly known method for aqueous suspension polymerization, block polymerization, solution polymerization, emulsion polymerization, or the like can be used. More specifically, with suspension polymerization, for example, vinyl chloride-based monomers, an aqueous medium, a dispersant, and a polymerization initiator are put into the polymerization vessel, the temperature is raised to a specific polymerization temperature, the polymerization reaction is conducted, and after the polymerization conversion of the vinyl chloride-based monomers has reached a specific ratio of 70 to 90 wt %, the system is cooled, the gas expelled, and the monomer removed, which gives a slurry containing PVC, and this slurry is dehydrated and dried to obtain the PVC.

Examples of the dispersant include water-soluble celluloses such as methyl cellulose, ethyl cellulose, hydroxy ethyl cellulose, hydroxypropylmethyl cellulose; water-soluble macromolecules such as partial saponification polyvinyl alcohol, polyethylene oxide, acrylate polymer, gelatine; water-soluble emulsifiers such as sorbitan monolaurate, polyoxyethylene sorbitan monolaurate, and the like.

Examples of the polymerization initiator include, for example, lauroyl peroxide; peroxy carbonates such as diisopropyl peroxy carbonate, di-2-ethyl hexyl peroxy carbonate, diethoxyethyl peroxy carbonate; peroxy esters such as α-cumy peroxyneodecanate, t-butyl peroxyneodecanate, t-butyl peroxypivalate, t-hexyl peroxyneodecanate; azo compounds such as 2,2-azobis isobutyronitrile, 2,2-azobis-2,4-dimethylvaleronitrile, 2,2-azobis-(4-methoxy-2,4-dimethylvaleronitrile), and the like.

Any polymerization regulator, chain transfer, pH regulator, antistatic agent, cross-linker, stabilizer, filler, antioxidant, scale inhibitor, and the like that is normally used in the polymerization of vinyl chloride may also be added.

The chlorine content of the CPVC of the present invention is preferably 65 wt % or higher. If the chlorine content is less than 65 wt %, the increase in heat resistance will tend to be inadequate.

Also, if particularly high heat resistance is required, the chlorine content is preferably 69 wt % or higher, or 70 wt % or higher, and this will also afford better workability.

In this case, it is preferable that —CCl₂-contained in the molecular structure is in an amount of 17.0 mol % or less, —CHCl— is in an amount of 46.0 mol % or higher, and —CH₂— is in an amount of 37.0 mol % or less.

The ratios of —CCl₂—, —CHCl—, and —CH₂— contained in the molecular structure of the CPVC reflect the position where the chlorine is introduced in the chlorination of the PVC. Ideally, the PVC prior to chlorination will be about 0 mol % —CCl₂—, 50.0 mol % —CHCl—, and 50.0 mol % —CH₂—.

The proportion of —CH₂— decreases and those of —CHCl— and —CCl₂— increase as chlorination proceeds (as the degree of chlorination rises). Here, if there is too much increase in —CCl₂— which is unstable and has a large steric hindrance, or if there is bias in the positions intended or not intended for chlorination in the same particle of CPVC, the chlorination state will be very non-homogeneous, and there will be a considerable loss of thermal stability. Therefore, the various components in the molecular structure are preferably within the ranges given above.

It is particularly preferable for the chlorine content of the CPVC to be (1) 65 wt % or higher, and less than 69 wt %, (2) 66 wt % or higher, and less than 69 wt %, (3) 69 wt % or higher, or (4) 69 wt % or higher, and less than 72 wt %.

In the case that the chlorine content is (1) and (2), it is preferable if the proportions are 6.2 mol % or less of —CCl₂—, 58.0 mol % or higher of —CHCl—, and 35.8 mol % or less of —CH₂— in the molecular structure. This purpose is to keep the effect of this non-uniform chlorination to a minimum and increase thermal stability. It is also preferable to keep the —CCl₂— to 5.9 mol % or less, the —CHCl— to 59.5 mol % or higher, and the —CH₂— to 34.9 mol % or less. This purpose is to keep because thermal stability will be particularly good.

In the case that the chlorine content is (3) and (4), it is preferable if the proportions are 17.0 mol % or less of —CCl₂—, 46.0 mol % of higher of —CHCl—, and 37.0 mol % or less of —CH₂— in the molecular structure. As the degree of chlorination of the CPVC rises, there is more —CCl₂—, and the chlorination state tends to be more non-uniform, but thermal stability can be further increased by staying within this range. It is more preferable if the proportions are 16.0 mol % or less of —CCl₂—, 53.5 mol % or higher of —CHCl—, and 30.5 mol % or less of —CH₂—.

The CPVC of the present invention preferably has 30.0 mol % or less of tetrad or higher vinyl chloride units (hereinafter referred to as VC units) contained in the molecular structure, and more preferably 28.0 mol % or less.

In particular, in the case that the chlorine content of the CPVC of the present invention is (3) and (4), it is preferable if the CPVC preferably has 18.0 mol % or less of tetrad or higher vinyl chloride units contained in the molecular structure.

The VC units present in the CPVC become starting points for HCl removal, and if these VC units are continuous, a continuous HCl removal reaction called a zipper reaction will tend to occur. In other words, the greater is the amount of these tetrad or higher VC units, the more readily HCl removal occurs, and the lower is the thermal stability.

The above-mentioned “VC units” are unchlorinated PVC units, and are —CH₂—CHCl—, while the “tetrad or higher VC units” refer to units in which four or more VC units are continuously bonded.

With the CPVC of the present invention, it is preferable for the UV absorbance to be 8.0 or less at a wavelength of 216 nm. In particular, in the case that the chlorine content of the CPVC of the present invention is (1) and (2), it is preferable to be 0.8 or less.

With the CPVC, hetero structures in the molecular chain during the chlorination reaction can be quantified from the value of the UV absorbance, and this serves as an index of thermal stability. With the CPVC, a chlorine atom attached to a carbon adjacent a double-bonded carbon is unstable, so it serves as a starting point for HCl removal. In other words, the greater is the value of UV absorbance, the more readily HCl removal occurs, and the lower is the thermal stability.

In general, to obtain a CPVC with a high degree of chlorination, a material is exposed to UV rays or a catalyst for an extended period during chlorination or is left at a high temperature for an extended period, so there are more hetero structures in the molecular chain of the CPVC, which tends to result in a considerable loss of thermal stability. If the UV absorbance value is over 8.0, the effect of hetero structures in the molecular chain will be more pronounced and thermal stability will tend to suffer.

The UV absorbance is measured by a method in which the ultraviolet absorption spectrum is measured, and reading the value of the UV absorbance at a wavelength of 216 nm, which is the absorption had by —CH═CH—C(═O) and —CH═CH—CH═CH—, which are hetero structures in the CPVC.

The above-mentioned CPVC is preferably such that the time it takes for the amount of HCl removal at 190° C. to reach 7000 ppm is 50 seconds or more, and more preferably 60 seconds or more, and even more preferably 70 seconds or more.

In particular, in the case that the chlorine content of the CPVC of the present invention is (3) and (4), it is preferably such that the time it takes for the amount of HCl removal at 190° C. to reach 7000 ppm is 100 seconds or more, and more preferably 120 seconds or more, and even more preferably 140 seconds or more.

With CPVC, how long it takes for the amount of HCl removal at 190° C. to reach 7000 ppm can be used as an index of thermal stability. CPVC undergoes pyrolysis when exposed to a high temperature, at which point HCl gas is generated. That is, the shorter is the time it takes for the amount of HCl removal at 190° C. to reach 7000 ppm, the lower is the thermal stability.

As the degree of chlorination of CPVC rises, the VC units which are unchlorinated PVC units decrease, so the amount of HCl removal thereof tends to decrease. However, at the same time, an increase in hetero structures or a non-uniform chlorination state occurs, which lowers thermal stability, so the amount of HCl removal must be kept low.

The CPVC of the present invention is a resin obtained by the chlorination of PVC, and the chlorination can be accomplished by any method known in the past. For instance, it is preferable to introduce liquid chlorine or chlorine gas into the reactor in a state in which PVC has been suspended in an aqueous medium in the reactor.

The reaction vessel is preferably a sealable, pressure-resistant vessel equipped with a stirrer, a heater, a cooler, a pressure reducer, a light irradiation apparatus, and the like. This reaction vessel can be made of any commonly used material, such as glass-lined stainless steel or titanium.

There are no particular restrictions on the method for putting the PVC in a suspended state, but a PVC cake may be obtained by subjecting a polymerized PVC to monomer removal treatment, or a dried product may be suspended again in an aqueous medium. Alternatively, a suspension from which any substances that are undesirable for the chlorination reaction have been removed from the polymerization system may be used. It is especially preferable to use a resin cake obtained by subjecting a polymerized PVC to monomer removal treatment. There are no particular restrictions on the amount of aqueous medium supplied to the reactor, but 2 to 10 weight parts per 100 weight parts of PVC is generally preferable.

There are no particular restrictions on the chlorine, which can be introduced in a liquid or gas state. In terms of the process, it is more efficient to use liquid chlorine, but chlorine gas may be blown in as needed to top up the chlorine as the chlorination reaction proceeds or to adjust the pressure in the course of the reaction. It is preferable to use chlorine that is 100 ppm or less, preferably 10 ppm of the oxygen concentration in the chlorine.

There are no particular restrictions on the gauge pressure in the reactor, but a range of 0.3 to 2 MPa is preferable because the higher is the chlorine pressure, the more readily the chlorine will penetrate into the interior of the PVC particles.

The pressure is preferably reduced inside the reaction vessel and the oxygen removed prior to the introduction of the chlorine. If too much oxygen is present, it can hamper the control of the chlorination reaction, so it is preferable to reduce the pressure so that the amount of oxygen in the reaction vessel will be 100 ppm or less. In this case, if the chlorine is supplied in a small amount, the chlorination reaction will proceed slowly, but if the amount is large, when the reaction is finished there will be a large quantity of chlorine left over, which is economically undesirable, so the supply is preferably adjusted so that the chlorine partial pressure in the reaction vessel will be 0.03 to 0.5 MPa.

There are no particular restrictions on the method for chlorinating the PVC, but examples include a method in which the excitation of bonding of PVC and chlorine is brought about by heat to accelerate the chlorination (hereinafter referred to as heat chlorination), a method in which light is exposed on the system to accelerate the chlorination by photoreaction (hereinafter referred to as photo-chlorination), and a method in which light is exposed while the system is heated.

There are no particular restrictions on the heating method during chlorination by thermal energy, but heating with an external jacket from the reactor walls is effective, for example. In particular, there is a tendency for the chlorination rate to drop along with the reaction temperature when chlorination is performed by heating alone, and if the reaction temperature is too high, a dehydrochlorination will occur in parallel with the chlorination reaction, and the resulting CPVC tends to be discolored, so the temperature is preferably 70 to 140° C., and more preferably 100 to 135° C.

When ultraviolet rays or other such optical energy is used, an apparatus is necessary that is capable of optical energy irradiation, such as ultraviolet irradiation, under conditions of high temperature and pressure. The chlorination reaction temperature in the case of photo-chlorination is preferably 40 to 80° C.

In the chlorination, hydrogen peroxide may be added, rather than performing optical irradiation. If the hydrogen peroxide is added in too small an amount, it tends to reduce the effect of increasing the chlorination rate, but if the amount is too large, the heat resistance of the resulting CPVC tends to be lower, so the added amount is preferably 5 to 500 ppm per hour with respect to the PVC. The reaction temperature when hydrogen peroxide is added is preferably 60 to 140° C., and more preferably 65 to 110° C. because the chlorination rate will be increased by the addition of the hydrogen peroxide.

Among the above-mentioned chlorination methods, a heat chlorination method involving no UV irradiation is preferred, and a method in which the excitation of bonding of PVC and chlorine is brought about by heat alone or by heat and hydrogen peroxide to accelerate the chlorination reaction is preferable.

With a chlorination reaction involving UV irradiation, the amount of optical energy needed to chlorinate the PVC is greatly affected by the distance between the PVC and the light source. Thus, the amount of energy is different inside and on the surface of the PVC particles, making uniform chlorination more difficult. In contrast, with a method in which no UV irradiation is performed, and chlorination is effected by bonding the PVC or exciting the chlorine with heat alone or with heat and hydrogen peroxide, a more uniform chlorination reaction will be possible, and the thermal stability of the CPVC can be increased.

Productivity tends to decrease as the chlorination becomes slower, and when it becomes faster, a dehydrochlorination reaction occurs, the resulting CPVC is discolored, and the heat resistance also tends to decrease. Thus, with the present invention, it is preferable to control the chlorination rate, that is, the chlorine consumption rate, in the chlorination of the PVC.

Examples of ways to control the chlorine consumption rate include varying the amount of optical irradiation, the reaction temperature, and the amount of added hydrogen peroxide.

As the distance of optical irradiation increases, more energy is lost, so the reaction tends to proceed only near the optical irradiation apparatus, and this makes it difficult to keep the reaction uniform. To get around this problem, stirring efficiency must be increased considerably, and the equipment must be modified to this end. Also, the performance of the optical irradiation apparatus must be enhanced to increase the optical irradiation intensity. However, this makes the equipment larger or requires the installation of another optical irradiation apparatus, so modifications are not easily achieved, and are expensive.

If the temperature is high from the start of the reaction (the glass transition temperature of the PVC or higher), the chlorination rate will be faster, but at the same time the PVC itself will undergo a dehydrochlorination reaction, and the temperature will have to be set within a range at which there will be no adverse effect on thermal stability or the like, so the range over which the reaction temperature can be controlled is narrowed. Furthermore, the equipment will have to be augmented, such as adding peripheral equipment or using a reaction vessel that can withstand high temperatures, and this can be expensive.

Under a given set of conditions, the chlorination rate will vary with how well the chlorination proceeds. This is because as the chlorination proceeds, reactions other than chlorine addition occur at the same time, such as the reaction proceeding preferentially from sites in the PVC structure where chlorine is easier to add, or when the chlorine content is over the specified level, the amount of energy needed to add the chlorine structurally increases and unstable chlorine undergoes dehydrochlorination. This and the like can result in complicated reactions.

Because of this, at an early stage of the chlorination reaction, the chlorination rate can usually be kept high by optical irradiation and heating temperature alone, but from the middle to the late stages of the chlorination reaction, the rate drops too low with these energy sources, and it is known that the chlorination rate can become extremely slow. To compensate for this, a peroxide such as hydrogen peroxide can be added as a catalyst, which allows the reaction velocity to be increased.

When hydrogen peroxide is used as a catalyst for the chlorination reaction, the reaction velocity can be controlled by the addition rate and the concentration of the hydrogen peroxide. In particular, hydrogen peroxide disperses quickly and uniformly in an aqueous medium. The addition rate can be easily controlled with a pump or the like. Thus, this is extremely well suited to control that matches the progress of the chlorination.

When hydrogen peroxide is added at an early stage of the chlorination reaction, the reaction velocity will, of course, be higher than normal, and the chlorination reaction time itself can be shortened. However, if the reaction is too fast, an exothermic reaction will occur, and a dehydrochlorination reaction and the like that usually occur at a later stage of the chlorination reaction will tend to occur at an early stage, so the CPVC will end up having more double bonds, branches, and other unstable structures than usual, and there will be a decrease in performance in terms of initial coloration and thermal stability, which are the most important.

If hydrogen peroxide is added, for example, from the middle stage to the late stage of the chlorination reaction, the system can be controlled so that the reaction velocity does not drop off. If no addition is made, it will take longer to reach the chlorine content of the final product, and productivity will suffer greatly. If an attempt is made to maintain productivity by raising the heating temperature, this will have little effect, and thermal stability will be lowered by the greater thermal hysteresis received during the chlorination reaction time.

Because of this, when hydrogen peroxide is added, for example, how much the chlorination proceeds (the chlorine content) and the chlorine consumption rate can be controlled, productivity can be increased, the production of unstable structures can be suppressed, thermal hysteresis can be minimized, and so forth and a CPVC with excellent thermal stability can be obtained.

With a conventional method for manufacturing CPVC (see Patent Document 1, for example), an improvement in productivity and initial colorization is attained by controlling the chlorine consumption rate at the point when the chlorine content reaches 60 wt %. However, when this method is applied the same way to a product with a chlorine content of 65 wt % or higher, there will be an effect on performance such as thermal stability, but the higher is the chlorine content, the lower is the productivity. This is because even if the chlorine content of the CPVC varies during the reaction, the reaction velocity is not controlled accordingly.

With the present invention, the chlorine consumption rate can be controlled in stages by means of the chlorine content of the CPVC, which allows productivity to be kept high while effectively suppressing the generation of unstable structures.

For example, there is a method in which the chlorine consumption rate is controlled within a range of 0.005 to 0.05 kg·PVC-kg·min in two stages of up to 5 wt % and up to 3 wt % less than the chlorine content of the manufactured CPVC.

This CPVC manufacturing method is particularly well suited to the manufacture of CPVC with a chlorine content of 65 wt % or higher, but the higher is the chlorine content, the lower is the productivity. Also, thermal stability is decreased when numerous unstable structures are produced. To achieve both high productivity and good thermal stability, the chlorination rate would be controlled precisely.

Therefore, in the chlorination of the PVC, if a CPVC is obtained whose final chlorine content is 65 wt % or higher, but less than 70 wt %, it is preferable to control the chlorination at the point of reaching up to 5 wt % away from the final chlorine content so that the chlorine consumption rate will be between 0.010 and 0.015 kg/PVC-kg·5 min, and chlorination from the point of reaching up to 3 wt % and onward so that the chlorine consumption rate will be between 0.005 and 0.010 kg/PVC-kg·5 min.

Also, if a CPVC is obtained whose final chlorine content is 70 wt % or more, but preferably less than 72 wt %, it is preferable to control the chlorination at the point of reaching up to 5 wt % away from the final chlorine content and onward so that the chlorine consumption rate will be between 0.015 and 0.020 kg/PVC-kg·5 min, and chlorination from the point of reaching up to 3 wt % and onward so that the chlorine consumption rate will be between 0.005 and 0.015 kg/PVC-kg·5 min.

Consequently, a CPVC with excellent thermal stability is obtained, with good uniformity in the chlorination state.

The above-mentioned control of the chlorine consumption rate may be performed in stages or all at once, but is preferably performed gradually.

The molded article of the present invention is obtained by molding the above-mentioned CPVC.

Any conventional manufacturing method may be employed to manufacture the molded article, but examples include extrusion molding and injection molding. The molded article thus obtained will have excellent thermal stability.

The molded article may be added any stabilizer, lubricant, processing aid, impact modifier, thermally-resistant agent, antioxidant, ultraviolet absorbent, light stabilizer, filler, pigment, and the like as needed.

The stabilizer is not particularly restricted but includes a heat stabilizer, an auxiliary heat stabilizer, and the like.

The heat stabilizer is not particularly restricted but includes, for example, organo tin stabilizers such as dibutyltin mercaptide, dioethyltin mercaptide, dimethyltin mercaptides, dibuthltin mercaptides, dibutyltin maleate, dibutyltin maleate polymer, dioctyltin maleate, dioctyltin maleate polymer, dibutyltin laurate and dibutyltin laurate polymer; lead stabilizers such as lead stearate, dibasic lead phosphite and tribasic lead sulfate; calcium-zinc stabilizers; barium-zinc stabilizers; barium-cadmium stabilizers, and the like. These may be used individually or in mixtures of two or more.

The auxiliary stabilizer is not particularly restricted but includes, for example, epoxi-dized soybean oil, phosphate esters, polyol, hydrotalcite, zeolite, and the like. These may be used individually or in mixtures of two or more.

The lubricant includes internal lubricants and external lubricants.

The internal lubricant is used for the purpose of lowering the fluid viscosity of the molten resin during molding, and prevent the generation of frictional heat. The internal lubricant is not particularly restricted but includes, butyl stearate, lauryl alcohol, stearyl alcohol, epoxy bean oil, glycerin monostearate, stearic acid, bisamide, and the like. These may be used individually or in mixtures of two or more.

The external lubricant is used for the purpose of improving the slip effect between metal surfaces and the molten resin during molding. The external lubricant is not particular restricted but includes, for example, paraffin wax, polyethylene wax, ester wax, montanic acid wax, and the like. These may be used individually or in mixtures of two or more.

The above processing aid is not particularly restricted but includes, for example, acrylic processing aids such as alkyl acrylate-alkyl methacrylate copolymers having a weight average molecular weight of 100,000 to 2,000,000. The above acrylic processing aid is not particularly restricted but includes, for example, n-butyl acrylate-methyl methacrylate copolymers, 2-ethylhexyl acrylate-methyl methacrylate-butyl methacrylate copolymers, and the like. These may be used individually or in mixtures of two or more.

The impact modifier is not particularly restricted but includes, for example, methyl methacrylate-butadiene-styrene copolymer (MBS), chlorinated polyethylene, acrylic rubber, and the like.

The thermally-resistant agent is not particularly restricted but includes, for example, α-methylstyrenes, N-phenyl maleimide-base resin, and the like.

The antioxidant is not particularly restricted but includes, for example, phenolic antioxidant, and the like.

The ultraviolet absorbent is not particularly restricted but includes, for example, salicylate-based, benzophenone-based, benzotriazole-based, cyanoacrylate-based, and the like.

The light stabilizer is not particularly restricted but includes, for example, hindered amines, and the like.

The filler is not particularly restricted but includes, for example, calcium carbonate, talc, and the like.

The pigment is not particularly restricted but includes, for example, organic pigments such as azo-based, phthalocyanine-based and threne based, pigments and dye lakes-based; inorganic pigments such as oxide-based, molybdenum chromate-based, sulfides-selenide-based, and ferrocyanide-based, and the like.

A plasticizer may be added to the molded article for the purpose of improving workability, but since this will reduce the heat resistance of the molded article, using a large amount is not very desirable. The plasticizer is not particularly restricted but includes, for example, dibutyl phthalate, di-2-ethylhexyl phthalate, di-2-ethylhexyl adipate, and the like.

A thermoplastic elastomer may be added to the molded article for the purpose of making it easier to work with. There are no particular restrictions on the thermoplastic elastomer, but includes, for example, an acrylonitrile-butadiene copolymer (NBR), an ethylene-vinyl acetate copolymer (EVA), an ethylene-vinyl acetate-carbon monoxide copolymer (EVACO); a vinyl chloride-based thermoplastic elastomer such as a vinyl chloride-vinyl acetate copolymer, a vinyl chloride-vinylidene chloride copolymer; a styrene-based thermoplastic elastomer, an olefine-based thermoplastic elastomer, an urethane-based thermoplastic elastomer, a polyester-based thermoplastic elastomer, a polyamide-based thermoplastic elastomer, and the like. The thermoplastic elastomer may be used individually or in mixtures of two or more.

There are no particular restrictions on the method for mixing additives into the CPVC, but examples include hot blending, cold blending, and the like.

Working examples of the CPVC, molded article thereof, and method for manufacturing CPVC of the present invention will now be described, but are not limited to the following examples.

### Working Example 1

### Preparation of Chlorinated Vinyl Chloride Resin

50 weight parts PVC with an average degree of polymerization of 1000 and 200 weight parts deionized water were supplied to a glass-lined reaction vessel with an internal capacity of 300 liters, and the contents were stirred to disperse the PVC uniformly in the deionized water, after which the pressure was reduced to remove the oxygen from inside the reaction vessel, and the temperature was raised to 90° C. No ultraviolet irradiation was performed in the course of this chlorination.

Next, chlorine was supplied to the reaction vessel so that the chlorine partial pressure would be 0.4 MPa, a chlorination reaction was conducted while 1 weight part of 0.2 wt % hydrogen peroxide was supplied per hour (320 ppm/hour), and the reaction was continued until the chlorine content of the chlorinated vinyl chloride resin reached 62 wt %.

Then, at the point when the chlorine content of the chlorinated vinyl chloride resin reached 62 wt % (5 wt % away), the amount in which the 0.2 wt % hydrogen peroxide was added was reduced to 0.1 weight part per hour (200 ppm/hour), the average chlorine consumption rate was adjusted to be 0.012 kg/PVC-kg·5 min, chlorination was allowed to proceed, the amount in which the 0.2 wt % hydrogen peroxide was added was reduced to 150 ppm/hour at the point of reaching 64 wt % (3 wt % away), the average chlorine consumption rate was adjusted to be 0.008 kg/PVC-kg·5 min, chlorination was allowed to proceed, and a chlorinated vinyl chloride resin with a chlorine content of 66.9 wt % was obtained.

### Production of Molded CPVC

1.5 weight parts organotin stabilizer (trade name ONZ-100F, made by Sankyo Organic Chemicals), 8 weight parts impact modifier (trade name M511, made by Kanegafuchi Chemical), 1 weight part lubricant (trade name Hiwax 2203A, made by Mitsui Chemical), and 0.5 weight part lubricant (trade name SL800, made by Riken Vitamin) were added to 100 weight parts of the chlorinated vinyl chloride resin obtained above, and the components were stirred and mixed to obtain a CPVC composition. The resulting CPVC composition was supplied to an extruder (trade name SLM-50, made by Nagata Seisakusho) and extrusion molded at an extruded resin temperature of 205° C. and a screw speed of 19.5 rpm. This produced a pipe-shaped article with an outside diameter of 20 mm and a thickness of 3 mm.

### Working Example 2

50 weight parts PVC with an average degree of polymerization of 1000 and 200 weight parts deionized water were supplied to a glass-lined reaction vessel with an internal capacity of 300 liters, and the contents were stirred to disperse the PVC uniformly in the deionized water, after which the pressure was reduced to remove the oxygen from inside the reaction vessel, and the temperature was raised to 100° C. No ultraviolet irradiation was performed in the course of this chlorination.

Next, chlorine was supplied to the reaction vessel so that the chlorine partial pressure would be 0.4 MPa, a chlorination reaction was conducted while 1 weight part of 0.2 wt % hydrogen peroxide was supplied per hour (320 ppm/hour), and the reaction was continued until the chlorine content of the chlorinated vinyl chloride resin reached 62 wt %.

Then, at the point when the chlorine content of the chlorinated vinyl chloride resin reached 62 wt % (5 wt % away), the amount in which the 0.2 wt % hydrogen peroxide was added was reduced to 0.1 weight part per hour (200 ppm/hour), the average chlorine consumption rate was adjusted to be 0.012 kg/PVC-kg·5 min, chlorination was allowed to proceed, the amount in which the 0.2 wt % hydrogen peroxide was added was reduced to 150 ppm/hour at the point of reaching 64 wt % (3 wt % away), the average chlorine consumption rate was adjusted to be 0.008 kg/PVC-kg·5 min, chlorination was allowed to proceed, and a chlorinated vinyl chloride resin with a chlorine content of 67.3 wt % was obtained.

A pipe-shaped article was obtained, using the resulting CPVC, in the same manner as in Working Example 1.

### Working Example 3

### Preparation of Chlorinated Vinyl Chloride Resin

50 weight parts PVC with an average degree of polymerization of 1000 and 200 weight parts deionized water were supplied to a glass-lined reaction vessel with an internal capacity of 300 liters, and the contents were stirred to disperse the PVC uniformly in the deionized water, after which the pressure was reduced to remove the oxygen from inside the reaction vessel, and the temperature was raised to 100° C. No ultraviolet irradiation was performed in the course of this chlorination.

Next, chlorine was supplied to the reaction vessel so that the chlorine partial pressure would be 0.4 MPa, a chlorination reaction was conducted while 1 weight part of 0.2 wt % hydrogen peroxide was supplied per hour (320 ppm/hour), and the reaction was continued until the chlorine content of the chlorinated vinyl chloride resin reached 66 wt %.

Then, at the point when the chlorine content of the chlorinated vinyl chloride resin reached 66 wt % (5 wt % away), the amount in which the 0.2 wt % hydrogen peroxide was added was reduced to 200 ppm/hour, the average chlorine consumption rate was adjusted to be 0.016 kg/PVC-kg·5 min, chlorination was allowed to proceed, the amount in which the 0.2 wt % hydrogen peroxide was added was reduced to 150 ppm/hour at the point of reaching 68 wt % (3 wt % away), the average chlorine consumption rate was adjusted to be 0.012 kg/PVC-kg·5 min, chlorination was allowed to proceed, and a chlorinated vinyl chloride resin with a chlorine content of 70.7 wt % was obtained.

### Production of Molded CPVC

2.0 weight parts organotin stabilizer (trade name ONZ-100F, made by Sankyo Organic Chemicals), 8 weight parts impact modifier (trade name M511, made by Kanegafuchi Chemical), 1.5 weight part lubricant (trade name Hiwax 2203A, made by Mitsui Chemical), and 1.0 weight part lubricant (trade name SL800, made by Riken Vitamin) were added to 100 weight parts of CPVC obtained above, and the components were stirred and mixed to obtain a CPVC composition. The resulting CPVC composition was supplied to an extruder (trade name SLM-50, made by Nagata Seisakusho) and extrusion molded at an extruded resin temperature of 205° C. and a screw rotating speed of 19.5 rpm. This produced a pipe-shaped article with an outside diameter of 20 mm and a thickness of 3 mm.

### Working Example 4

50 weight parts PVC with an average degree of polymerization of 1000 and 200 weight parts deionized water were supplied to a glass-lined reaction vessel with an internal capacity of 300 liters, and the contents were stirred to disperse the PVC uniformly in the deionized water, after which the pressure was reduced to remove the oxygen from inside the reaction vessel, and the temperature was raised to 110° C. No ultraviolet irradiation was performed in the course of this chlorination.

Next, chlorine was supplied to the reaction vessel so that the chlorine partial pressure would be 0.4 MPa, a chlorination reaction was conducted while 1 weight part of 0.2 wt % hydrogen peroxide was supplied per hour (320 ppm/hour), and the reaction was continued until the chlorine content of the chlorinated vinyl chloride resin reached 66 wt %.

Then, at the point when the chlorine content of the chlorinated vinyl chloride resin reached 66 wt % (5 wt % away), the amount in which the 0.2 wt % hydrogen peroxide was added was reduced to 0.1 weight part per hour (200 ppm/hour), the average chlorine consumption rate was adjusted to be 0.016 kg/PVC-kg·5 min, chlorination was allowed to proceed, the amount in which the 0.2 wt % hydrogen peroxide was added was reduced to 150 ppm/hour at the point of reaching 68 wt % (3 wt % away), the average chlorine consumption rate was adjusted to be 0.010 kg/PVC-kg·5 min, chlorination was allowed to proceed, and a chlorinated vinyl chloride resin with a chlorine content of 70.9 wt % was obtained.

A pipe-shaped article was obtained, using the resulting CPVC, in the same manner as in Working Example 3.

### Comparative Example 1

50 weight parts PVC with an average degree of polymerization of 1000 and 200 weight parts deionized water were supplied to a glass-lined reaction vessel with an internal capacity of 300 liters and equipped with a light irradiator therein, and the contents were stirred to disperse the PVC in the deionized water, after which the pressure was reduced to remove the oxygen from inside the reaction vessel, and the temperature was raised to 60° C.

Next, chlorine was supplied to the reaction vessel so that the chlorine partial pressure would be 0.05 MPa, a chlorination reaction was conducted with irradiation from a mercury lamp with intensity of 30 kwh, and the reaction was continued until the chlorine content of the chlorinated vinyl chloride resin reached 67.3 wt %.

A pipe-shaped article was obtained, using the resulting CPVC, in the same manner as in Working Example 1.

### Working Example 5

### Preparation of Chlorinated Vinyl Chloride Resin

50 weight parts PVC with an average degree of polymerization of 800 and 200 weight parts deionized water were supplied to a glass-lined reaction vessel with an internal capacity of 300 liters and equipped with a light irradiator therein, and the contents were stirred to disperse the PVC in the deionized water, after which the pressure was reduced to remove the oxygen from inside the reaction vessel, and the temperature was raised to 60° C.

Next, chlorine was supplied to the reaction vessel so that the chlorine partial pressure would be 0.05 MPa, a chlorination reaction was conducted with irradiation from a mercury lamp with intensity of 30 kwh, and the reaction was continued until the chlorine content of the chlorinated vinyl chloride resin reached 70.0 wt %.

A pipe-shaped article was obtained, using the resulting CPVC, in the same manner as in Working Example 3.

The chlorine content, UV absorbance, and HCl removal time were measured for the chlorinated vinyl chloride resins obtained in the above Working Examples 1 to 5 and Comparative Example 1, molecular structure analysis was performed, and the molar ratio of —CCl₂—, —CHCl—, and —CH₂— and the molar ratio of tetrad and higher VC units were measured, the results of which are shown in Table 1. The thermal stability of the resulting pipe-shaped article was measured, the results of which are shown in Table 1.

The measurements listed above were made by the following methods.

### (1) Measurement of Chlorine Content

This was measured according to JIS K 7229.

### (2) Molecular Structure Analysis

This was measured according to NMR measurement method described in R. A. Komoroski, R. G. Parker, J. P. Shocker, Macromolecules, 1985, 18, 1257-1265.

The conditions of the NMR measurement were made by the followings.

Apparatus: FT-NMRJEOLJNM-AL-300

Measurement Nuclear: 13C (protpne complete decoupling)

Pulse Width: 90°

PD: 2.4 sec

Medium: o-dichlorobenzene:Deuterated benzene(C5D5)=3:1

Concentration of Sample: about 20%

Temperature: 110° C.

Reference Substance Center Signal of Benzene of 128 ppm

Acumulated Number: 20000

### (3) Measurement of UV Absorbance (216 nm)

The UV absorbance at a wavelength of 216 nm was measured under the following conditions.

Apparatus: Self-recording Spectrophotometer (Hitachi Seisakusho U-3500)

Solvent: THF

Concentration: Sample 20 mg/THF 25 ml, 800 ppm (Exs. 1, 2 and Comp. Ex 1)

Sample 10 mg/THF 25 ml, 400 ppm (Exs. 3 to 5)

### (4) HCl Removal Time

1 g of the obtained chlorinated vinyl chloride resin was put in a test tube and heated to 190° C. in anoil bath. The HCl gas thus generated was recovered and dissolved in 100 mL of deionized water, and the pH was measured. The number of grams of HCl generated per million grams of chlorinated vinyl chloride resin was calculated from the pH value, and the time it took for this value to react 7000 ppm was measured.

### (5) Thermal Stability Evaluation

The pipe-shaped article thus obtained was cut to a size of 2×3 cm, and a specific number of these were placed in a 200° C. oven and taken out every 10 minutes to measure the blackening time.

TABLE 1

| | | | | | Comp. |
|---|---|---|---|---|---|
| Example | | | | | Ex. |
| 1 | 2 | 3 | 4 | 5 | 1 |

Chlorinated Vinyl Chloride Resin

| | | | | | | |
|---|---|---|---|---|---|---|
| Chlorine Content (wt %) | 66.9 | 67.3 | 70.7 | 70.9 | 70.0 | 67.3 |

Molecular Structure

| | | | | | | |
|---|---|---|---|---|---|---|
| —CCl₂— (mol %) | 6.1 | 5.8 | 16.6 | 15.0 | 12.5 | 5.6 |
| —CHCl— (mol %) | 58.6 | 60.2 | 47.7 | 56.3 | 52.8 | 57.6 |
| —CH₂— (mol %) | 35.3 | 34.0 | 35.7 | 28.7 | 34.7 | 36.8 |
| Tetrad & Higher VC Units | 26.8 | 26.4 | 15.7 | 10.7 | 22.2 | 33.2 |
| (mol %) | | | | | | |
| UV Absorbance (216 nm) | 0.7 | 0.6 | 5.7 | 7.4 | 8.3 | 1.3 |
| HCl Removal Time (sec.) | 80 | 78 | 152 | 181 | 72 | 32 |
| PVC Chlorine Content at | 62 | 62 | 66 | 66 | | |
| First Chlorine | | | | | | |
| Consumption Rate | | | | | | |
| Changing point (wt %) | | | | | | |
| Chlorine Consumption | 0.012 | 0.012 | 0.016 | 0.016 | | |
| Rate at First Chlorine | | | | | | |
| Consumption Rate | | | | | | |
| Changing point (1) | | | | | | |
| PVC Chlorine Content at | 64 | 64 | 68 | 68 | | |
| Second Chlorine | | | | | | |
| Consumption Rate | | | | | | |
| Changing point (wt %) | | | | | | |
| Chlorine Consumption | 0.008 | 0.008 | 0.012 | 0.010 | | |
| Rate at Second Chlorine | | | | | | |
| Consumption Rate | | | | | | |
| Changing point (2) | | | | | | |

Molded Article

| | | | | | | |
|---|---|---|---|---|---|---|
| Thermal Stability (min) | 100 | 110 | 80 | 80 | 70 | 70 |

### Working Example 6

50 weight parts PVC with an average degree of polymerization of 1000 and 200 weight parts deionized water were supplied to a glass-lined reaction vessel with an internal capacity of 300 liters, and the contents were stirred to disperse the PVC uniformly in the deionized water, after which the pressure was reduced to remove the oxygen from inside the reaction vessel, and the temperature was raised to 100° C. No ultraviolet irradiation was performed in the course of this chlorination.

Next, chlorine was supplied to the reaction vessel so that the chlorine partial pressure would be 0.4 MPa, a chlorination reaction was conducted while 0.2 wt % hydrogen peroxide was supplied to be 320 ppm/hour, and the reaction was continued until the chlorine content of the chlorinated PVC reached 62 wt %.

Then, at the point when the chlorine content of the chlorinated PVC reached 62 wt % (5 wt % away), the amount in which the 0.2 wt % hydrogen peroxide was added was reduced to 200 ppm/hour, the average chlorine consumption rate was adjusted to be 0.012 kg/PVC-kg·5 min, chlorination was allowed to proceed, the amount in which the 0.2 wt % hydrogen peroxide was added was reduced to 150 ppm/hour at the point of reaching 64 wt % (3 wt % away), the average chlorine consumption rate was adjusted to be 0.008 kg/PVC-kg·5 min, chlorination was allowed to proceed for 6.0 hours in total, and a CPVC with a chlorine content of 67 wt % was obtained.

### Working Example 7

50 weight parts PVC with an average degree of polymerization of 1000 and 200 weight parts deionized water were supplied to a glass-lined reaction vessel with an internal capacity of 300 liters, and the contents were stirred to disperse the PVC uniformly in the deionized water, after which the pressure was reduced to remove the oxygen from inside the reaction vessel, and the temperature was raised to 100° C. No ultraviolet irradiation was performed in the course of this chlorination.

Next, chlorine was supplied to the reaction vessel so that the chlorine partial pressure would be 0.4 MPa, a chlorination reaction was conducted while 0.2 wt % hydrogen peroxide was supplied to be 320 ppm/hour, and the reaction was continued until the chlorine content of the chlorinated PVC reached 66 wt %.

Then, at the point when the chlorine content of the chlorinated PVC reached 66 wt % (5 wt % away), the amount in which the 0.2 wt % hydrogen peroxide was added was reduced to 300 ppm/hour, the average chlorine consumption rate was adjusted to be 0.016 kg/PVC-kg·5 min, chlorination was allowed to proceed, the amount in which the 0.2 wt % hydrogen peroxide was added was reduced to 200 ppm/hour at the point of reaching 68 wt % (3 wt % away), the average chlorine consumption rate was adjusted to be 0.012 kg/PVC-kg ·5 min, chlorination was allowed to proceed for 9.0 hours in total, and a CPVC with a chlorine content of 71 wt % was obtained.

### Comparative Example 2

50 weight parts PVC with an average degree of polymerization of 1000 and 200 weight parts deionized water were supplied to a glass-lined reaction vessel with an internal capacity of 300 liters, and the contents were stirred to disperse the PVC uniformly in the deionized water, after which the pressure was reduced to remove the oxygen from inside the reaction vessel, and the temperature was raised to 100° C. No ultraviolet irradiation was performed in the course of this chlorination.

Next, chlorine was supplied to the reaction vessel so that the chlorine partial pressure would be 0.4 MPa, a chlorination reaction was conducted while 0.2 wt % hydrogen peroxide was supplied to be 320 ppm/hour, and the reaction was continued until the chlorine content of the chlorinated PVC reached 60 wt %.

Then, at the point when the chlorine content of the chlorinated PVC reached 60 wt % (7 wt % away), the amount in which the 0.2 wt % hydrogen peroxide was added was reduced to 150 ppm/hour, the average chlorine consumption rate was adjusted to be 0.005 kg/PVC-kg·5 min, chlorination was allowed to proceed for 8.0 hours, and a CPVC with a chlorine content of 67 wt % was obtained.

### Comparative Example 3

50 weight parts PVC with an average degree of polymerization of 1000 and 200 weight parts deionized water were supplied to a glass-lined reaction vessel with an internal capacity of 300 liters, and the contents were stirred to disperse the PVC uniformly in the deionized water, after which the pressure was reduced to remove the oxygen from inside the reaction vessel, and the temperature was raised to 100° C. No ultraviolet irradiation was performed in the course of this chlorination.

Next, chlorine was supplied to the reaction vessel so that the chlorine partial pressure would be 0.4 MPa, a chlorination reaction was conducted while 0.2 wt % hydrogen peroxide was supplied to be 320 ppm/hour, and the reaction was continued until the chlorine content of the chlorinated vinyl chloride resin reached 60 wt %.

Then, at the point when the chlorine content of the chlorinated PVC reached 60 wt % (11 wt % away), the amount in which the 0.2 wt % hydrogen peroxide was added, the average chlorine consumption rate was adjusted to be 0.012 kg/PVC-kg·5 min, chlorination was allowed to proceed for 5.8 hours, and a CPVC with a chlorine content of 67 wt % was obtained.

### Comparative Example 4

50 weight parts PVC with an average degree of polymerization of 1000 and 200 weight parts deionized water were supplied to a glass-lined reaction vessel with an internal capacity of 300 liters, and the contents were stirred to disperse the PVC uniformly in the deionized water, after which the pressure was reduced to remove the oxygen from inside the reaction vessel, and the temperature was raised to 100° C. No ultraviolet irradiation was performed in the course of this chlorination.

Next, chlorine was supplied to the reaction vessel so that the chlorine partial pressure would be 0.4 MPa, a chlorination reaction was conducted while 0.2 wt % hydrogen peroxide was supplied to be 320 ppm/hour, and the reaction was continued until the chlorine content of the chlorinated vinyl chloride resin reached 60 wt %.

Then, at the point when the chlorine content of the chlorinated PVC reached 60 wt % (11 wt % away), the amount in which the 0.2 wt % hydrogen peroxide was added and was reduced to 150 ppm/hour, the average chlorine consumption rate was adjusted to be 0.005 kg/PVC-kg·5 min, chlorination was allowed to proceed for 18 hours, and a CPVC with a chlorine content of 71 wt % was obtained.

A resin composition composed of 100 weight parts of the CPVC thus obtained, 1.5 weight parts organotin stabilizer (trade name ONZ-100F, made by Sankyo Organic Chemicals), 8 weight parts MBS impact modifier (trade name M511, made by Kaneka), 1 weight part acrylic working auxiliary (Metablen P-550, made by Mitsubishi Rayon), and 0.5 weight part stearic acid lubricant (trade name SL800, made by Riken Vitamin) was wrapped around a 195° C. roll and then roll kneaded for 3 minutes. The resulting sheet was subjected to a thermal aging test (200° C. for 140 minutes×10 times) that was a static thermal stability test, and the time it took for the sheet to blacken was measured.

1 g of the resulting CPVC was put in a 10 mL glass test tube and heated in 190° C. oil bath under a nitrogen gas flow, the hydrochloric acid generated from the CPVC was trapped in water, and the pH of this water was measured, thereby measuring the time it took for the amount of generated hydrochloric acid to reach 5000 ppm.

The chlorination conditions for the working and comparative examples¹ are shown in Table 2 along with the blackening time and the dehydrochlorination time.

TABLE 2

| | Example | | Comp. Ex. | | |
|---|---|---|---|---|---|
| | 6 | 7 | 2 | 3 | 4 |
| Chlorine Content of CPVC (wt %) | 67 | 71 | 67 | 67 | 71 |
| Average degree of | 1000 | 1000 | 1000 | 1000 | 1000 |
| polymerizationof PVC | | | | | |
| Reaction Temp. (° C.) | 100 | 100 | 100 | 100 | 100 |
| Reaction time (h) | 6 | 9 | 8 | 5.8 | 18 |
| PVC Chlorine Content at | 62 | 66 | 60 | 60 | 60 |
| First Chlorine Consumption Rate | | | | | |
| Changing point (wt %) | | | | | |
| Chlorine Consumption Rate | 0.012 | 0.016 | 0.005 | 0.012 | 0.005 |
| at First Chlorine Consumption | | | | | |
| Rate Changing point (1) | | | | | |
| PVC Chlorine Content at Second | 64 | 68 | — | — | — |
| Chlorine Consumption Rate | | | | | |
| Changing point (wt %) | | | | | |
| Chlorine Consumption Rate at | 0.008 | 0.012 | 0.005 | 0.012 | 0.005 |
| Second Chlorine Consumption | | | | | |
| Rate Changing point (2) | | | | | |
| Blackening Time (min) | 60 | 80 | 60 | 40 | 80 |
| HCl Removal Time (min) | 42 | 64 | 41 | 33 | 58 |

1-17. (canceled)

18. A chlorinated vinyl chloride-based resin in which
a chlorine content is 65 wt % or higher, and less than 69 wt %,
—CCl₂— is in an amount of 6.2 mol % or less,
—CHCl— is in an amount of 58.0 mol % or higher, and
—CH₂— is in an amount of 35.8 mol % or less contained in a molecular structure.

19. The chlorinated vinyl chloride-based resin of claim 18,
wherein —CCl₂— is in an amount of 5.9 mol % or less,
—CHCl— is in an amount of 59.5 mol % or higher, and
—CH₂— is in an amount of 34.6 mol % or less contained in a molecular structure.

20. The chlorinated vinyl chloride-based resin of claim 18, wherein a tetrad or higher vinyl chloride units contained in the molecular structure is 30.0 mol % or less.

21. The chlorinated vinyl chloride-based resin of claim 18, wherein UV absorbance at a wavelength of 216 nm is 0.8 or less.

22. The chlorinated vinyl chloride-based resin of claim 18, wherein the time required for reaching the amount of HCl removal of 7000 ppm at 190° C. is 50 seconds or more.

23. A chlorinated vinyl chloride-based resin in which
a chlorine content is 69 wt % or higher, and less than 72 wt %,
—CCl₂— is in an amount of 17.0 mol % or less,
—CHCl— is in an amount of 46.0 mol % or higher, and
—CH₂— is in an amount of 37.0 mol % or less contained in a molecular structure.

24. The chlorinated vinyl chloride-based resin of claim 23,
wherein —CCl₂— is in an amount of 16.0 mol % or less,
—CHCl— is in an amount of 53.5 mol % or higher, and
—CH₂— is in an amount of 30.5 mol % or less contained in a molecular structure.

25. The chlorinated vinyl chloride-based resin of claim 23, wherein a tetrad or higher vinyl chloride units contained in the molecular structure is 18.0 mol % or less.

26. The chlorinated vinyl chloride-based resin of claim 23, wherein UV absorbance at a wavelength of 216 nm is 8.0 or less.

27. The chlorinated vinyl chloride-based resin of claim 23, wherein the time required for reaching the amount of HCl removal of 7000 ppm at 190° C. is 100 seconds or more.

28. The chlorinated vinyl chloride-based resin of claim 18, comprising;
a chlorinated vinyl chloride-based resin under introducing liquid chlorine or chlorine gas into the reactor in a state in which vinyl chloride-based resin has been suspended in an aqueous medium.

29. The chlorinated vinyl chloride-based resin of claim 23, comprising;
a chlorinated vinyl chloride-based resin under the excitation of bonding of the vinyl chloride-based resin and chlorine without UV irradiation by heat alone or by heat and hydrogen peroxide.

30. The chlorinated vinyl chloride-based resin of claim 28, wherein the chlorination is brought about the excitation of bonding of the vinyl chloride-based resin and chlorine without UV irradiation by heat alone or by heat and hydrogen peroxide.

31. The chlorinated vinyl chloride-based resin of claim 29, wherein the chlorination is brought about the excitation of bonding of the vinyl chloride-based resin and chlorine without UV irradiation by heat alone or by heat and hydrogen peroxide.

32. A molded article molded with the chlorinated vinyl chloride-based resin of claim 18.

33. A molded article molded with the chlorinated vinyl chloride-based resin of claim 23.

34. A method for manufacturing a chlorinated vinyl chloride-based resin comprising dispersing a vinyl chloride-based resin in an aqueous medium inside a sealable reaction vessel, reducing a pressure in the reaction vessel, introducing chlorine into the vessel to chlorinate the vinyl chloride-based resin, the method comprising
controlling a chlorine consumption rate which is the amount of chlorine consumed in 5 minutes per kilogram of raw material vinyl chloride-based resin so that the chlorine consumption rate is in the range of 0.010 and 0.020 kg/PVC-kg·5 min at the point of reaching 5 wt % away from the final chlorine content of the chlorinated vinyl chloride-based resin, and so that the chlorine consumption rate is in the range of 0.005 and 0.015 kg/PVC-kg·5 min at the point of reaching 3 wt % away from the final chlorine content.

35. The method for manufacturing the chlorinated vinyl chloride-based resin of claim 34, wherein the chlorinated vinyl chloride-based resin having a final chlorine content of 65 wt % or higher, and less than 70 wt %, the method comprising
controlling the chlorine consumption rate so that the chlorine consumption rate is in the range of 0.010 and 0.015 kg/PVC-kg·5 min at the point of reaching 5 wt % away from the final chlorine content of the chlorinated vinyl chloride-based resin, and so that the chlorine consumption rate is in the range of 0.005 and 0.010 kg/PVC-kg·5 min at the point of reaching 3 wt % away from the final chlorine content.

36. The method for manufacturing the chlorinated vinyl chloride-based resin of claim 34, wherein the chlorinated vinyl chloride-based resin having a final chlorine content is 70 wt % or higher, the method comprising
controlling the chlorine consumption rate so that the chlorine consumption rate is in the range of 0.015 and 0.020 kg/PVC-kg·5 min at the point of reaching 5 wt % away from the final chlorine content of the chlorinated vinyl chloride-based resin, and so that the chlorine consumption rate is in the range of 0.005 and 0.015 kg/PVC-kg·5 min at the point of reaching 3 wt % away from the final chlorine content.

37. The method for manufacturing the chlorinated vinyl chloride-based resin of claim 34, wherein the chlorination is brought about the excitation of bonding of the vinyl chloride-based resin and chlorine without UV irradiation by heat alone or by heat and hydrogen peroxide.

38. The chlorinated vinyl chloride-based resin of claim 19, wherein UV absorbance at a wavelength of 216 nm is 0.8 or less, and the time required for reaching the amount of HCl removal of 7000 ppm at 190° C. is 50 seconds or more.

39. The chlorinated vinyl chloride-based resin of claim 19, comprising;
a chlorinated vinyl chloride-based resin under introducing liquid chlorine or chlorine gas into the reactor in a state in which vinyl chloride-based resin has been suspended in an aqueous medium, and under the excitation of bonding of the vinyl chloride-based resin and chlorine without UV irradiation by heat alone or by heat and hydrogen peroxide.
